(19) United States
(12) Patent Application Publication
(10) Pub. No.: US 2024/0004645 A1
(43) Pub. Date: Jan. 4, 2024

(54) Intermediate Representation Controller Circuit for Selecting Hardware Compute Units to Process Microcode According to Identified Intermediate Representation Primitives

(71) Applicant: Advanced Micro Devices, Inc., Santa Clara, CA (US)

(72) Inventors: Sergey Blagodurov, Bellevue Bellevue, WA (US); Ganesh Suryanarayanc Dasika, Austin, TX (US)

(73) Assignee: Advanced Micro Devices, Inc., Santa Clara, CA (US)

(21) Appl. No.: 17/854,434

(22) Filed: Jun. 30, 2022

(51) Int. Cl. G06F 9/22; G06F 9/30; G06N 3/04

(52) U.S. Cl. CPC G06F 9/226; G06F 9/223; G06N 3/04; G06F 9/30036; G06F 9/30025

(57) ABSTRACT

An intermediate representation (IR) controller is described that, for a given intermediate representation (IR) primitive, selects a hardware compute unit of a plurality of hardware compute units. In a non-limiting example, the IR controller receives an input that specifies an IR primitive, a device mask indicating a type of hardware circuitry to be used to process the primitive, and a goal vector specifying a goal in the processing of the primitive. The IR controller also collects data describing power consumption by respective hardware compute units and completion times for processing respective IR primitives. This data is maintained as implementation profiles that describe operation of respective hardware compute units in processing respective IR primitives, e.g., as histograms. The implementation profiles are then leveraged by the IR controller to select hardware compute units for execution of subsequent IR primitives.

### BACKGROUND

Hardware device design is continually optimized and expanded to increase functionality made available by these devices. For example, integrated circuits such as central processing units, parallel processing units, and so forth are configurable using hardware circuitry for optimization of corresponding functions, e.g., to render digital images. However, in some instances these increases in functionality are unable to keep pace with advances made in corresponding software that is to take advantage of this expansion. This results in inefficiencies in device operation as well as software that is to be executed to take advantage of these designs.

### BRIEF DESCRIPTION OF THE DRAWINGS

The detailed description is described with reference to the accompanying figures.

FIG. 1 is a block diagram of a non-limiting example system including an intermediate representation (IR) controller.

FIG. 2 is a block diagram of a non-limiting example system in which an intermediate representation controller is implemented as part of a microcode architecture.

FIG. 3 is a block diagram of a non-limiting example system in which operation of the intermediate representation controller is shown in greater detail.

FIG. 4 depicts a procedure in a non-limiting example implementation of processing control based on intermediate representation primitives using an intermediate representation controller.

FIG. 5 depicts a procedure in a non-limiting example implementation of processing control in which an additional implementation profile is added at runtime and used as a basis to control processing through use of intermediate representation primitives by an intermediate representation controller.

### DETAILED DESCRIPTION

Hardware design continually evolves to provide ever increasing amounts and varieties of functionality. In some instances, however, an amount of time involved in achieving changes to this functionality in hardware, itself, is incapable of keeping pace with corresponding changes in software, for which, the changes to the hardware were developed. An example of this is machine learning in which hardware is optimized for corresponding machine learning software.

Neural networks (e.g., deep neural networks), for instance, increasingly employ features such as control flow, dynamic data structures, dynamic tensor shapes, and so on. Thus, neural networks typically involve continual changes to a significant number of operators with varying data types and shapes. As such, in some conventional scenarios, hardware designed to optimize functionality of these models becomes quickly outdated, as new software primitives are constantly proposed and evolved by machine-learning researchers that are not compatible (i.e., “understood”) by a corresponding hardware design or that are executed, inefficiently, by a corresponding hardware design, e.g., processing takes too long or consumes too much power.

To solve these problems, an intermediate representation (IR) controller is described that, for a given intermediate representation (IR) primitive, selects a hardware compute unit of a plurality of hardware compute units. In one example, the IR controller is implemented within a hub (e.g., as a standalone device) attached to switches that communicatively couple the hardware compute units to the controller. In another example, the IR controller is implemented in hardware circuitry as part of a compute board (e.g., machine learning compute board) to control execution of IR primitives by respective hardware compute units, e.g., central processing units, parallel processing units (e.g., graphics processing units), floating point grid arrays, tensor processing units, and so on.

The IR controller, for instance, receives an input that specifies an IR primitive, a device mask indicating a type of hardware circuitry to be used to process the primitive, and a goal vector specifying a goal in the processing of the primitive, e.g., to conserve power or prioritize performance. The IR controller also collects data describing power consumption by respective hardware compute units and completion times for processing respective IR primitives. This data is maintained as implementation profiles that describe operation of respective hardware compute units in processing respective IR primitives, e.g., as histograms. In an implementation, this data is collected “offline” during idle times by launching IR primitives on selected hardware compute units to generate the profiles.

The implementation profiles are then leveraged by the IR controller to select hardware compute units for execution of subsequent IR primitives. In an example microcode implementation, a writeable control store is leveraged that supports updates to the IR primitives as well as updates to the implementation profiles. This permits the IR controller to adapt in real time to changes in the IR primitives as well as hardware compute units that are subsequently developed. As such, the IR controller is configured to adapt to these changes, which is not possible in conventional techniques and devices. A variety of other instances are also contemplated, examples of which are described in the following discussion and shown using corresponding figures.

In some aspects, the techniques described herein relate to a method including: receiving an input identifying an intermediate representation (IR) primitive of a plurality of intermediate representations primitives; identifying at least one implementation profile from a plurality of implementation profiles based on the input, the plurality of implementation profiles describing operation of a plurality of microcode implementations in processing respective the IR primitives; selecting a microcode implementation from the plurality of microcode implementations based on the at least one implementation profile; and invoking processing of microcode corresponding to the IR primitive by the selected microcode implementation.

In some aspects, the techniques described herein relate to a method, wherein the input further identifies a goal and the selecting of the microcode implementation from the plurality of microcode implementations is based at least in part on the goal.

In some aspects, the techniques described herein relate to a method, wherein the goal set a priority to performance or power efficiency.

In some aspects, the techniques described herein relate to a method, wherein the input further identifies a device mask specifying a type of hardware circuitry to be used to processing the IR primitive and the identifying or the selecting is based at least in part of the circuitry type.

In some aspects, the techniques described herein relate to a method, wherein the input is received from a neural network.

In some aspects, the techniques described herein relate to a method, further including detecting operating conditions of hardware compute units corresponding to the plurality of microcode implementations and wherein the selecting is based at least in part on the detected operating conditions.

In some aspects, the techniques described herein relate to a method, wherein the hardware compute units are implemented by a central processing unit, parallel processing unit, floating point grid array, or tensor processing unit.

In some aspects, the techniques described herein relate to a method, further including: receiving feedback data describing operation of the selected microcode implementation in processing the microcode; and updating the at least one implementation profile based on the feedback data.

In some aspects, the techniques described herein relate to a method, further including updating one or more of the plurality of implementation profiles offline.

In some aspects, the techniques described herein relate to a method, wherein the receiving, the identifying, the selecting, and the invoking are performed by a controller implemented in hardware circuitry and the plurality of implementation profiles are maintained as part of writeable microcode in a writeable control store (WCS).

In some aspects, the techniques described herein relate to an intermediate representation (IR) controller including: an input module configured to receive an input identifying an intermediate representation (IR) primitive; a profiler manager module configured to collect data in a writeable control store as a plurality of implementation profiles, the plurality of implementation profiles describing operation of a plurality of hardware compute units in processing, respectively, a plurality of microcode implementations; and an actuator module configured to select a hardware compute unit of the plurality of hardware compute units to process microcode corresponding to the IR primitive.

In some aspects, the techniques described herein relate to an intermediate representation (IR) controller, wherein the input module, the profiler module, and the actuator module are implemented in hardware circuitry.

In some aspects, the techniques described herein relate to an intermediate representation (IR) controller, wherein the plurality of implementation profiles describe the operation using histograms.

In some aspects, the techniques described herein relate to an intermediate representation (IR) controller, wherein the histograms describe power consumption or performance.

In some aspects, the techniques described herein relate to an intermediate representation (IR) controller, wherein the actuator module is configured to select the hardware compute unit based on operating conditions detected for the plurality of hardware compute units.

In some aspects, the techniques described herein relate to an intermediate representation (IR) controller, wherein the input further identifies a goal prioritizing performance or power efficiency and the actuator module is configured to select the hardware compute unit from the plurality of hardware compute units based on the goal.

In some aspects, the techniques described herein relate to an intermediate representation (IR) controller, wherein the input further identifies a device mask specifying a type of hardware circuitry to be used to processing the IR primitive and the actuator module is configured to select the hardware compute unit from the plurality of hardware compute units based at least in part on the circuitry type.

In some aspects, the techniques described herein relate to a method including: generating a plurality of implementation profiles by an intermediate representation (IR) controller based on data collected from and describing operation of a plurality of hardware compute units in processing microcode corresponding to an intermediate representation (IR) primitive; forming an additional implementation profile by the IR controller based on data collected from an additional hardware compute unit made available by communicatively coupling the additional hardware compute unit to the IR controller; receiving an input at the IR controller to cause processing of the IR primitive; determining by the IR controller which of the plurality of hardware compute units, including the additional hardware compute unit, is to be used to process the IR primitive based on the plurality of implementation profiles and the additional implementation profile; and invoking processing of microcode corresponding to the IR primitive at the determined hardware compute unit by the IR controller.

In some aspects, the techniques described herein relate to a method, wherein the forming, the received, the determining, and the invoking are performed in real time.

In some aspects, the techniques described herein relate to a method, wherein the generating is performed offline.

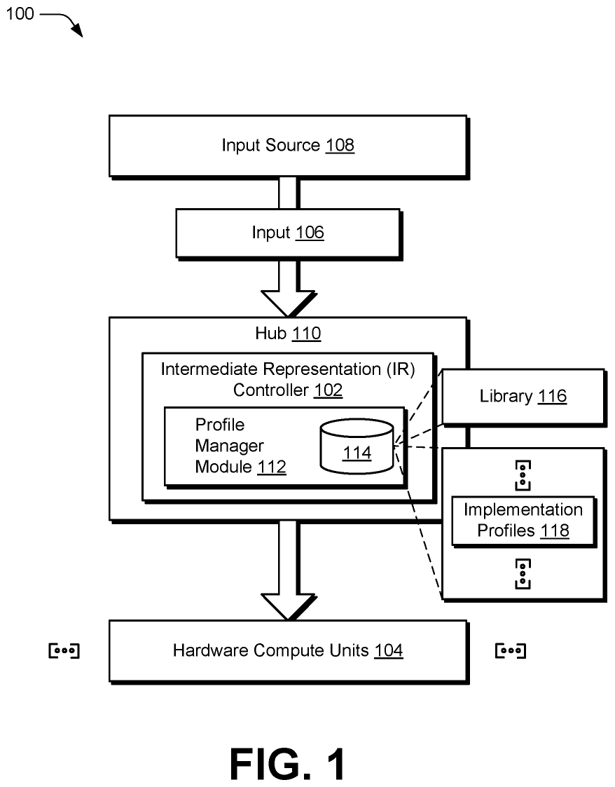

FIG. 1 is a block diagram of a non-limiting example system 100 including an intermediate representation (IR) controller 102. The IR controller 102 is configured to control and manage use of hardware compute units 104 to process respective inputs 106 received from an input source 108. In the illustrated example, this is performed by the IR controller 102 within a hub 110 as a centralized point of communication between the input source 108 and the hardware compute units 104.

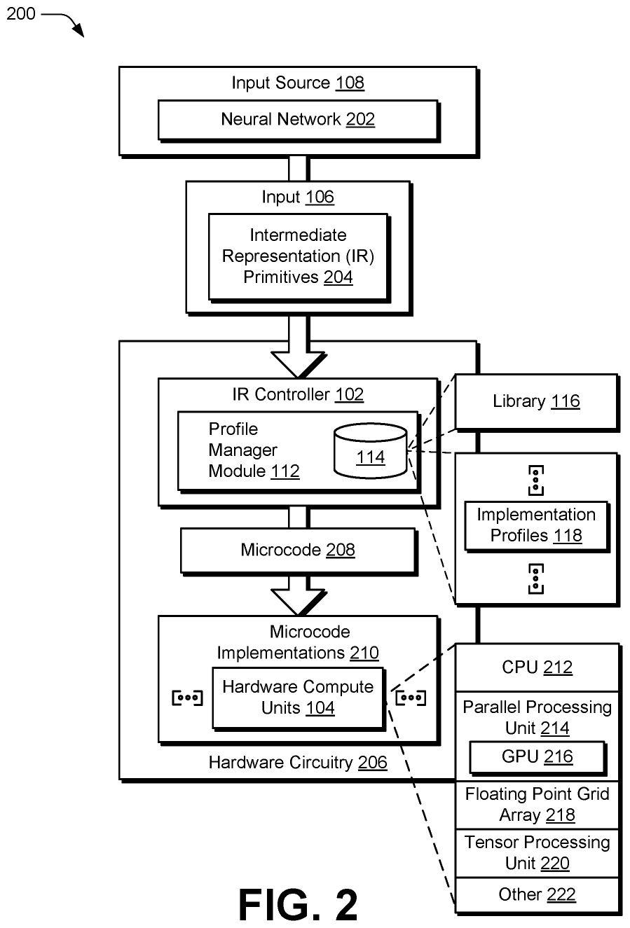

The hub 110, for instance, is configurable as a standalone device having switches to control operation to respective hardware compute units 104, e.g., servers, processing devices, and so on. In another example as further described beginning at a discussion of FIG. 2, the IR controller 102 is configured in hardware circuitry to control utilization of corresponding hardware compute units 104 using microcode, such as central processing units, parallel processing units, floating point grid arrays, tensor processing units, and so on.

The intermediate representation (IR) controller 102 and hardware compute units 104 are configurable as and includable in a variety of devices. Examples of those devices include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the IR controller 102 and hardware compute units 104 are configured as any one or more of those devices listed just above and/or a variety of other devices without departing from the spirit or scope of the described techniques.

As part of managing access to and use of the hardware compute units 104, the IR controller 102 includes a profile manager module 112 and writeable storage 114 (e.g., a writeable control store implemented using random access memory) that maintains a library 116 and a plurality of implementation profiles 118. The library 116 is updateable to support changes in functionality to be made available via the hardware compute units 104, e.g., through use of respective intermediate representation primitives as described in greater detail in the following figure. The implementation profiles 118 describe operation of respective hardware compute units 104 in processing respective inputs 106, e.g., regarding power consumption or amount of time taken to process respective inputs 106. In this way, the IR controller 102 and corresponding profile manager module 112 support updates to functionality supported by the library 116 as well as changes in hardware compute units 104 accessible by the hub 110 in this example. This acts to protect against obsolescence of hardware designs.

FIG. 2 is a block diagram of a non-limiting example system 200 in which an intermediate representation controller is implemented as part of a microcode architecture. As previously described, in some conventional real world scenarios hardware design is not capable of keeping pace with continued changes to software and hardware that is to take advantage of those changes. An example of this is machine learning, illustrated through inclusion of a neural network 202 as part of the input source 108 in this figure.

In conventional techniques, everchanging demands of machine-learning software make optimization of corresponding machine learning hardware untenable. Neural networks, for instance, increasingly make use of features such as control flow, dynamic data structures, and dynamic tensor shapes. These dynamic models utilize a significant number of operators with varying data types and shapes. As a result, hardware optimized for these features is quickly outdated in conventional scenarios as a result of constantly changes to the software proposed by machine learning researchers.

Accordingly, the IR controller 102 is configured to support intermediate representation (IR) primitives 204 that are updateable as part of the library 116 maintained in writeable storage 114 of the IR controller 102. The library 116, for instance, is operable as updatable microcode that resides in dedicated high-speed memory of the writeable storage 114 and functions as a translation layer between an input from the input source 108 (e.g., instruction set architecture (ISA) instructions that the programmer or compiler “sees”) and hardware circuitry 206 implementing the hardware compute units 104 in this example.

When software is written, source code is converted into ISA instructions by assemblers and compilers. At execution time, the ISA instructions are converted into microinstructions, and the microinstructions cause transistors to open and close in the hardware circuitry 206. Microcode enables a computer designer to create ISA instructions without knowledge of design of particular hardware circuits that are used to execute the instructions. It also facilitates complex multi-step instructions, while reducing the complexity of computer circuits.

In a way, an input 106 configured as an ISA instruction “calls” into the library 116 (e.g., implemented as a “microcode library”) for execution. In conventional techniques the microcode library is often “hardened” for execution and thus does not support changes or updates. In the techniques and devices described herein, on the other hand, the library 116 is configured to support implementation of new IR primitives desired by machine learning researchers using a stable underlying hardware architecture. Further, the profile manager module 112 is configured to control which hardware compute units 104 are to be used to process the IR primitives 204.

In the illustrated example, the IR controller 102 receives an input 106 specifying IR primitives 204. This is performable directly as a “ucode” implementation or indirectly as a kernel that is subsequently converted. The profile manager module 112 of the IR controller 102 also maintains implementation profiles 118 as “up-to-date” based on data describing power readings from each of the hardware compute units 104 as well as completion times of each IR primitive 204, e.g., as a measure of performance.

For each IR primitive, for instance, the implementation profiles 118 are maintained that describe performance and/or power as a histogram of its executions on different types of hardware compute units 104. To do so in one implementation, the profile manager module 112 launches the IR primitives 204 on respective hardware compute units 104 when idle and measures power consumption and/or performance to generate and update the implementation profiles 118. Based on the implementation profiles 118, the profile manager module 112 selects a particular hardware compute unit from the plurality of hardware compute units 104 for execution.

The illustrated system 200 is configured to support the IR primitives 204 and hardware compute units 104 using microcode 208 and corresponding microcode implementations 210. Microcode 208 is configured to control device operation at the level of hardware circuitry 206. For example, microcode 208 in a typical microinstruction includes operations to connect registers to particular sides of a floating point unit, set the floating point unit to perform two's-complement addition, set the floating point unit to carry an input to zero, store a result in a particular register, update condition codes based on status flags, and then perform a micro jump for a next microinstruction.

Neural networks 202 as described above make use of features such as control flow, dynamic data structures, and dynamic tensor shapes. These dynamic models involve a significant number of operators with varying data types and shapes. Accordingly, microcode 208 in this example is positioned to support IR primitives 204 that address the features added to hardware compute units 104. For example, conditions for a control flow involving an IR primitive 204 are usable to define how registers/memory connect to arithmetic-logic units (ALUs) and floating-point units (FPUs), specialized hardware compute units such as tensor processing units (TPUs), and so on. In another example, dynamic data structures are definable by a family of related (i.e., “overloaded”) IR primitives 204 that take an input of varying size and then map it to existing registers or static random access memory (SRAM) buffers of the device in the microcode implementation, or to memory if registers or SRAM are not available on that particular device.

Moreover, through use of writeable microcode supported by the library 116 maintained by the writeable storage 114, new and previously unknown features at the time of device creation is straightforward. Rather than store the microcode 208 in ROM or hard-wired logic, the microcode 208 in the illustrated example of FIG. 2 is stored in writeable storage 114 implemented using RAM as a writable control store or “WCS.” Loading of the microcode 208 to the writeable storage 114 is performable in a variety of ways. In a first example, early loading updates the microcode during device boot, e.g., before an “initramfs” stage that is a mode usually used to fix severe hardware bugs. In a second example, late loading is performed to update the microcode 208 in the library 116 after booting and can be used to apply a newer microcode update without rebooting the device. In a third example, built-in microcode is compiled into an OS kernel that is then applied using an early loader.

The IR controller 102 in this example is configured to support microcode instructions for added/updated IR primitives 204 and well as to control which hardware compute units 104 are used to execute the microcode 208 corresponding to the IR primitives 204. In an example, multiple microcode implementations 210 are usable for a same IR primitive 204, each of which activate different heterogeneous circuitry of hardware compute units 104 within a device. Examples of hardware compute units 104 include a central processing unit 212, parallel processing unit 214 (e.g., a graphics processing unit 216), floating point grid array 218, tensor processing unit 220, and other 222 hardware functionality. The IR controller 102 is configurable as an application specific integrated circuit, microcontroller, or other 222 hardware circuitry. Function of the IR controller 102 is described in greater detail in the following discussion and shown in a corresponding figure.

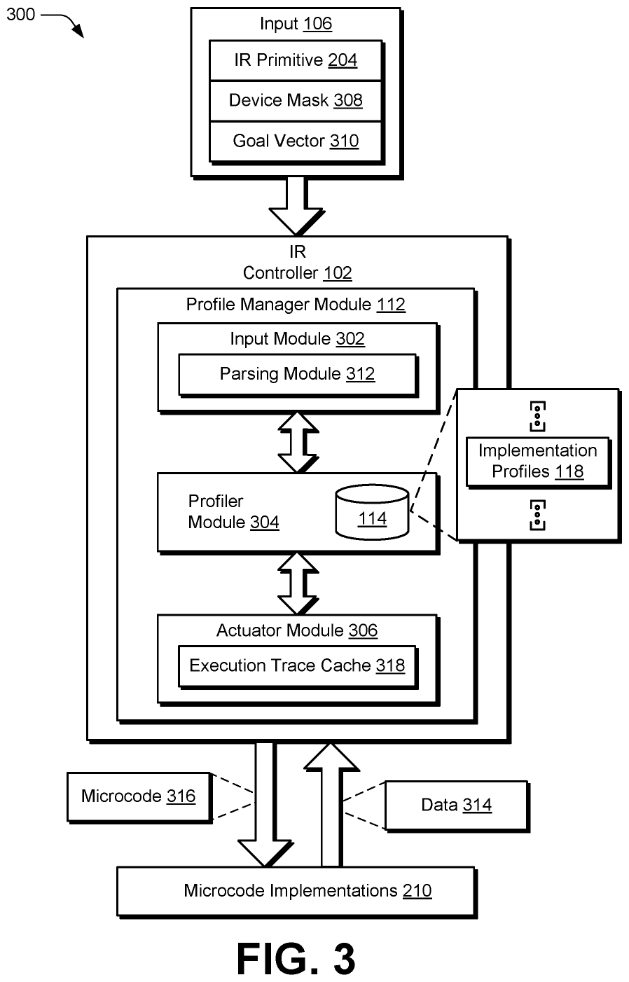

FIG. 3 is a block diagram of a non-limiting example system 300 in which operation of the intermediate representation controller is shown in greater detail. Functionality of the profile manager module 112 of FIG. 2 is implemented in this example using an input module 302, a profile module 304, and an actuator module 306.

The input module 302 takes as an input an IR primitive 204 to be executed. The input 106 in this example also includes additional information usable to control which microcode implementations 210 (and corresponding hardware compute units 104) are to be used to process the IR primitives 204. The input 106, for instance, includes an optional device mask 308 that, for each IR primitive 204, specifies which circuitry type (e.g., CPUs, GPUs, FPGAs, tensor processing units) are to be used to process the IR primitives 204. In this way, the input source 108 includes functionality to specify how the IR primitive 204 is to be processed and thus is given a degree of control of that processing, without being aware of particular hardware compute units 104 that are used in actuality.

The input 106 also includes a goal vector 310 (i.e., goal) that specifies a goal in processing of the IR primitives 204. Again, this permits a degree of control by the input source 108 to specify “how” processing is performed. The goal vector 310, for instance, is configured to specify whether performance or power saving are be given a relatively higher priority when implementing the IR primitives 204. If performance is chosen, available hardware compute units 104 with expected lower intermediate representation primitive completion time receive the IR primitive 204 for execution instead of hardware compute units 104 having increased power efficiency. In an implementation, the device mask 308 and the goal vector 310 are specified as a configuration parameter via model-specific registers (MSRs).

In the illustrated example, the input module 302 includes a parsing module 312 that is configured to parse the input 106 to identify “what” (i.e., particular IR primitives 204) are included in the input 106. This is performable in a variety of ways, such as to break the input 106 into chunks and calculate a checksum for each chunk. This permits the profiler module 304 to optimize as a history of knowing “what is best for each chunk” as further described below.

The profile module 304 is configured to receive data 314 from the microcode implementations 210 and more particularly the hardware compute units 104 that are utilized by these implementations. The data 314 is configurable to describe operation of the microcode implementations 210, which is usable as a basis to generate the implementation profiles 118.

The profile module 304, for instance, receives up-to-date power readings from each of the hardware compute units 104. The profile module 304 also measures an amount of time taken by respective hardware compute units 104 to process respective IR primitives 204, which is stored as corresponding implementation profiles 118. In an example, the data 314 describes completion time of IR primitives as it clocks the moments each IR primitive is started and finished on the circuitry activated by one of the several microcode implementations 210 for this IR primitive 204.

Thus, the profile module 304 is configured to collect performance (e.g., completion time) and energy consumption (e.g., performance/watt) data corresponding to each of the microcode implementations 210 corresponding to different types of hardware compute units 104, e.g., central processing unit 212, parallel processing unit 214 (e.g., GPU), floating point grid array 218, tensor processing unit 220, and other 222 types of circuitry. In an implementation, the profile module 304 is also configured to dynamically “fill in the gaps” in the implementation profiles 118 offline. This is performable by scanning microcode implementations 210 of the input IR primitives 204 and identifying missing performance and/or power consumption metrics. In response, the profile manager module 112 launches a microprogram on its circuitry when it is available. Thus, the profiler gradually collects the performance and energy efficiency of each circuitry type for each given IR primitive, e.g., “offline” during idle times.

The actuator module 306 is configured to select a microcode implementation from the plurality of microcode implementations 210 (and thus corresponding hardware compute units 104) to execute the IR primitives 204. This is performable by taking into account current operating conditions of the hardware compute units 104, circuitry specified by the optional device mask 308, a goal indicated by the goal vector 310, and so forth.

To do so in one non-limiting example, the actuator module 306 first selects a subset of eligible microcode implementations 210 that (a) use circuitry that is specified by the optional device mask 308 and (b) are not currently occupied by other IR primitives. The actuator module 306 then determines relevant operational conditions for the IR primitives 204, e.g., by reading performances statistics and/or energy consumption statistics from data collected form the microcode implementations 210 and corresponding hardware compute units 104. Based on this data, the actuator module 306 then selects a microcode implementation from the plurality of microcode implementations 210 to execute microcode 316 corresponding to the IR primitives 204. In an implementation, the selected microcode implementation is then decoded and stored in an execution trace cache 318 to avoid repeated decoding of the same IR primitive and thus improve device operation. Data 314 resulting from execution of the IR primitive 204 by the microcode implementations 210 is used to update corresponding implementation profiles 118 by the profiler module 304, and thus adapts to operational changes in real time and during runtime, which is not possible in conventional fixed techniques.

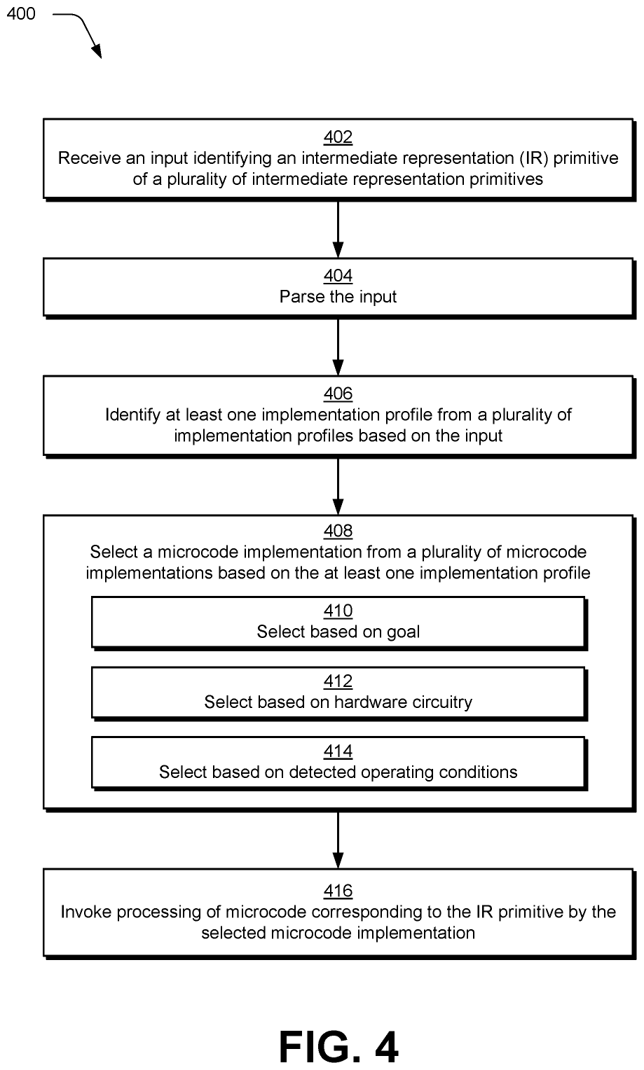

FIG. 4 depicts a procedure 400 in an example implementation of processing control based on intermediate representation primitives using an intermediate representation controller.

An input is received identifying an intermediate representation (IR) primitive of a plurality of intermediate representation primitives (block 402). By way of example, an input 106 is received by an input module 302 of the IR controller 102. The input 106 identifies the IR primitive 204 that is to be executed. In one instance, the IR primitive 204 received from a neural network 202 involves targeted functionality of the neural network 202. The input 106 is also configurable to include a device mask 308 specifying hardware circuitry to be used to process the IR primitive 204, a goal vector 310 defining a goal in how the IR primitive 204 is to be processed (e.g., performance versus power conservation), and so forth.

The input is parsed (block 404). By way of example, the input 106 is broken into chunks. Checksums are calculated for each of the chunks by the input module 302 and used to identify the IR primitives 204.

At least one implementation profile is identified from a plurality of implementation profiles based on the input (block 406). By way of example, the plurality of implementation profiles 118 describe operation of a plurality of microcode implementations 210 in processing respective IR primitives 204. The profile module 304, for instance, generates and maintains implementation profiles 118 through updates based on data describing operation of respective hardware compute units 104 used by the microcode implementations 210 for particular IR primitives 204.

A microcode implementation is selected from a plurality of microcode implementations based on the at least one implementation profile (block 408). By way of example, the microcode implementation is selected based on goal (block 410). The goal, for instance, is definable by a goal vector 310 to priority energy efficiency, performance, distribute implementation by respective hardware compute units 104 (e.g., load balancing), and so forth. By way of another example, the microcode implementation is selected based on hardware circuitry (block 412). The optional device mask 308, for instance, defines hardware circuitry identified by the input source 108 usable to process the IR primitive 204. By way of a further example, the microcode implementation is selected based on detected operating conditions (block 414). The actuator module 306, for instance, receives data 314 used by the profile module 304 to update the implementation profiles 118, which describes performance of the microcode implementations 210. The implementation profiles 118 are then used by an actuator module 306 to select a particular implementation profile, e.g., based on current operating conditions, the optional device mask 308, the microcode implementations 210, and so forth.

Processing of microcode corresponding to the IR primitive by the selected microcode implementation is invoked (block 416). By way of example, microcode 316 corresponding to the IR primitive 204 is processed by hardware compute units 104 corresponding to the selected microcode implementations 210.

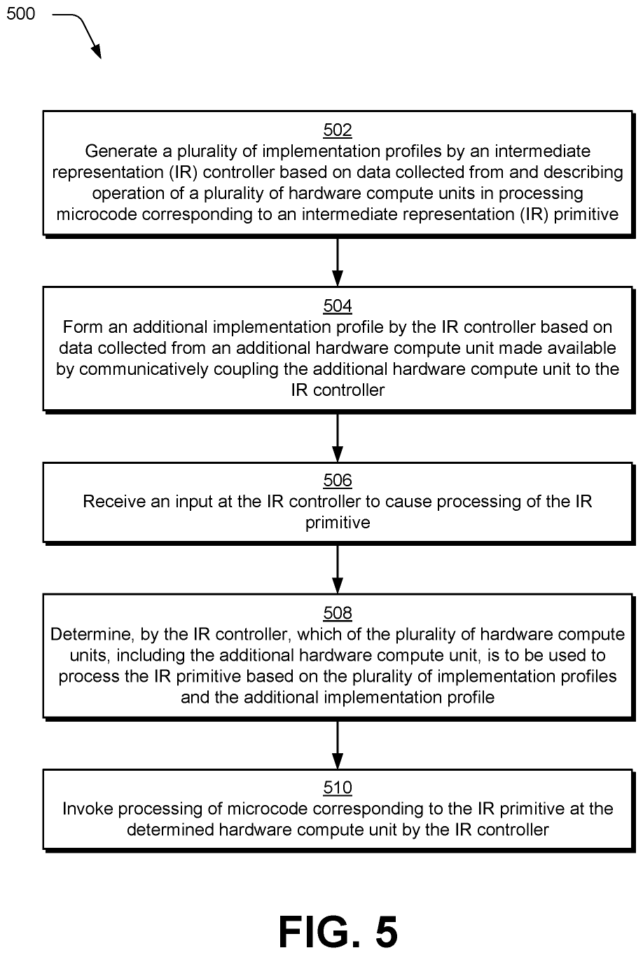

FIG. 5 depicts a procedure 500 in an example implementation of processing control in which an additional implementation profile is added at runtime and used as a basis to control processing through use of intermediate representation primitives by an intermediate representation controller.

A plurality of implementation profiles are generated by an intermediate representation (IR) controller based on data collected from and describing operation of a plurality of hardware compute units in processing microcode corresponding to an intermediate representation (IR) primitive (block 502). By way of example, a profile module 304 receives data describing operation of the hardware compute units 104, and from this, generates the implementation profiles 118, e.g., as histograms.

An additional implementation profile is formed by the IR controller based on data collected from an additional hardware compute unit made available by communicatively coupling the additional hardware compute unit to the IR controller (block 504). By way of example, an additional microcode implementation 210 and corresponding hardware compute unit 104 is communicatively coupled to the IR controller 102 via a bus, network connection, and so forth. Responsive to this, the profile module 304 generates a corresponding implementation profile describing performance and/or energy use during idle time, which is maintained in writeable storage 114.

An input is received at the IR controller to cause processing of the IR primitive (block 506). By way of example, the input 106 specifies an IR primitive also added to the library 116 maintained by the writeable storage 114.

A determination is made by the IR controller as to which of the plurality of hardware compute units, including the additional hardware compute unit, is to be used to process the IR primitive based on the plurality of implementation profiles and the additional implementation profile (block 508). By way of example, the actuator module 306 utilizes the previously stored implementations profiles 118 as well as the “newly added” implementation profile to select a corresponding hardware compute unit 104.

Processing of microcode corresponding to the IR primitive is invoked at the determined hardware compute unit by the IR controller (block 510). By way of example, microcode 316 corresponding to the newly added IR primitive 204 is executed by a respective microcode implementation 210 implemented by a respective hardware compute unit 104. Other examples are also contemplated.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the intermediate representation (IR) controller 102 and hardware compute units 104) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A method comprising:
receiving, by a controller circuit, from a neural network, an input identifying a goal vector and a specific intermediate representation (IR) primitive of a plurality of IR primitives, the goal vector defining a goal in how the specific IR primitive is to be processed;
identifying, by the controller circuit, at least one implementation profile from a plurality of implementation profiles based on the input, the plurality of implementation profiles describing operation of a plurality of microcode implementations in processing respective ones of the plurality of IR primitives;
selecting, by the controller circuit, a microcode implementation from the plurality of microcode implementations based on the at least one implementation profile and the goal; and
invoking, by the controller circuit, processing of microcode corresponding to the specific IR primitive by the selected microcode implementation.

2. The method of claim 1, wherein the selecting of the microcode implementation from the plurality of microcode implementations is based at least in part on the goal in how the specific IR primitive is to be processed.

3. The method of claim 2, wherein the goal in how the specific IR primitive is to be processed specifies whether performance or power efficiency is to be given a relatively higher priority when implementing the specific IR primitive.

4. The method of claim 1, wherein the input further identifies a device mask specifying a type of hardware circuitry to be used to process the specific IR primitive and the identifying or the selecting is based at least in part on the type.

5. (canceled)

6. The method of claim 1, further comprising detecting, by the controller circuit, operating conditions of hardware compute units corresponding to the plurality of microcode implementations and wherein the selecting is based at least in part on the detected operating conditions.

7. The method of claim 6, wherein the hardware compute units are implemented by a central processing unit, parallel processing unit, floating point grid array, or tensor processing unit.

8. The method of claim 1, further comprising:
receiving, by the controller circuit, data describing operation of the selected microcode implementation in processing the microcode; and
updating, by the controller circuit, the at least one implementation profile based on the data.

9. The method of claim 1, further comprising updating, by the controller circuit, one or more of the plurality of implementation profiles offline.

10. The method of claim 1, wherein the plurality of implementation profiles are maintained as part of writeable microcode in a writeable control store.

11. An intermediate representation (IR) controller circuit comprising:
an input module circuit configured to receive an input from a neural network, the input identifying a goal vector and an IR primitive, and the goal vector defining a goal in how the IR primitive is to be processed;
a profiler manager module circuit configured to collect data in a writeable control store as a plurality of implementation profiles, the plurality of implementation profiles describing operation of a plurality of hardware compute units in processing, respectively, a plurality of microcode implementations; and
an actuator module circuit configured to select, based on the goal, a specific hardware compute unit of the plurality of hardware compute units to process microcode corresponding to the IR primitive.

12. (canceled)

13. The IR controller circuit of claim 11, wherein the plurality of implementation profiles describe the operation using histograms.

14. The IR controller circuit of claim 13, wherein the histograms describe power consumption or performance.

15. The IR controller circuit of claim 11, wherein the actuator module circuit is configured to select the specific hardware compute unit based on operating conditions detected for the plurality of hardware compute units.

16. The IR controller circuit of claim 11, wherein the goal in how the IR primitive is to be processed specifies whether performance or power efficiency is to be given a relatively higher priority when implementing the IR primitive.

17. The IR controller circuit of claim 11, wherein the input further identifies a device mask specifying a type of hardware circuitry to be used to process the IR primitive and the actuator module circuit is configured to select the hardware compute unit from the plurality of hardware compute units based at least in part on the type.

18. A method comprising:
generating a plurality of implementation profiles by an intermediate representation (IR) controller circuit based on data collected from and describing operation of a plurality of hardware compute units in processing microcode corresponding to an IR primitive;
forming an additional implementation profile by the IR controller circuit based on data collected from an additional hardware compute unit made available by communicatively coupling the additional hardware compute unit to the IR controller circuit;
receiving an input at the IR controller circuit to cause processing of the IR primitive;
determining by the IR controller circuit which hardware compute unit of the plurality of hardware compute units, including the additional hardware compute unit, is to be used to process the IR primitive based on the plurality of implementation profiles and the additional implementation profile; and
invoking processing of microcode corresponding to the IR primitive at the hardware compute unit by the IR controller circuit.

19. The method of claim 18, wherein the forming, the receiving, the determining, and the invoking are performed in real time.

20. The method of claim 18, wherein the generating is performed offline while at least a portion of the plurality of hardware compute units are idled.

21. The method of claim 18, wherein receiving the input comprises receiving the input from machine learning software.

22. The method of claim 21, wherein receiving the input comprises receiving the input from a neural network.
